(19) United States
(12) Patent Application Publication
(10) Pub. No.: US 2007/0055488 A1
(43) Pub. Date: Mar. 8, 2007

(54) Method for web-based simulation triage

(76) Inventor: Slavenko Elez, Austin, TX (US)

Correspondence Address: IBM CORPORATION (SWP), C/O SUITER SWANTZ PC LLO, 14301 FNB PARKWAY, SUITE 220, OMAHA, NE, 68154-5299, US

(21) Appl. No.: 11/222,083

(22) Filed: Sep. 8, 2005

(51) Int. Cl. G06F 9/45

(52) U.S. Cl. 703/22

(57) ABSTRACT

The present invention uses simulation fail signature as the only visible mark of a simulation fail as a starting point of communication in the verification process. Further, the present invention defines actions that need to be taken at each system integration level which may provide a written history in simple html format for each logic block/model on that level. Additionally, the present invention proposes a format and organization of a system of html files that may contain information that may be used for tracking and reporting purposes on each level and may later be used for debug on higher system integration levels. Moreover, the web-based simulation triage method of the present invention bridges information between a simulation database and a problem-tracking database in a user-friendly format that may easily be processed with text processing scripts, either on the tools development side, or by a triage person, or both.

### FIELD OF THE INVENTION

The present invention relates to the field of system design and particularly to a method for web-based simulation triage.

### BACKGROUND OF THE INVENTION

The triage process is extremely important in complex, hierarchical system design. Typically, the triage process involves analyzing simulation results for one or more releases of one or more models at a first integration level. A next step in the triage process involves determining which releases are sufficiently functional based on the analysis of the simulation results. Releases determined to be sufficiently functional are combined/integrated on a second integration level and simulation is performed to test the functionality of the releases when combined. The goal of the triage process is to integrate releases in a manner that will ultimately result in a system design with minimal simulation errors/bugs. If properly done, the triage process may save a lot of engineering time and it may significantly increase debug efficiency. Nevertheless, the triage process is frequently neglected in the sense that the process is not clearly defined and often forces less experienced engineers to find their way around. For instance, engineers attempting to integrate releases at a later integration level may not have a clear record or indication of what occurred at earlier integration levels.

Generally, the triage process is performed on each integration level based on fails (i.e., simulation errors) that are available in a simulation database. After initial debug, a simulation triage file is open in a problem (issue) tracking database. There are several problems related to this approach that relates to both databases. The simulation database contains temporary, redundant and incomplete data of simulation runs. The data in the simulation database is temporary because disk space for storing simulation results is often limited. Consequently, the data typically is deleted by the system, either at scheduled intervals or manually by users. The simulation database contains redundant data because, most of the time, there are multiple fails caused by the same problem and usually only samples are analyzed in detail. Also, each of those samples are usually incomplete to save disk space. Consequently, the samples are rerun and analyzed in a more stable and less restricted environment. This leaves little room for effective triage and communication between different levels of design hierarchy.

The problem (issue) tracking database lists all problems permanently with more or less description than the simulation database. However, it is usually very hard to sort files in a way that provides a comprehensive and organized history of simulation fails for each model (i.e., logic block) release on each level of design integration. This is mostly due to the fact that each user is entering simulation information arbitrarily to serve his or her own needs without thinking of future users. While the above approach ensures that the problem being worked on at that time may be solved, it does not provide sufficient communication between different levels of design integration. Consequently, this causes duplication and delays of debug processes, and also results in bad prioritization of debug activities.

Therefore, it would be desirable to have a method for web-based simulation triage which may provide a comprehensive and organized history of design integration and simulation fails that may be easily communicated between different verification groups or design groups. It would be further desirable to have a method for web-based simulation triage which may provide a comprehensive and organized history of design integration and simulation fails that may be used for reporting purposes.

### SUMMARY OF THE INVENTION

Accordingly, the present invention uses simulation fail signature as the only visible mark of a simulation fail as a starting point of communication in the verification process. Further, the present invention defines actions that need to be taken at each system integration level which may provide a written history in simple html format for each logic block/model on that level. Additionally, the present invention proposes a format and organization of a system of html files that may contain information that may be used for tracking and reporting purposes on each level and may later be used for debug on higher system integration levels. Moreover, the web-based simulation triage method of the present invention bridges information between a simulation database and a problem-tracking database in a user-friendly format that may easily be processed with text processing scripts, either on the tools development side, or by a triage person, or both.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a diagram illustrating an exemplary triage process system integration scheme for implementation with a method for web-based simulation triage of the present invention;

FIG. 2 is a flowchart illustrating a method for web-based simulation triage in accordance with an embodiment of the present invention; and

FIG. 3 is a diagram illustrating an exemplary triage process system reverse integration scheme for implementation with a method for web-based simulation triage of the present invention.

### DETAILED DESCRIPTION OF THE INVENTION

Reference will now be made in detail to the presently preferred embodiments of the invention, examples of which are illustrated in the accompanying drawings.

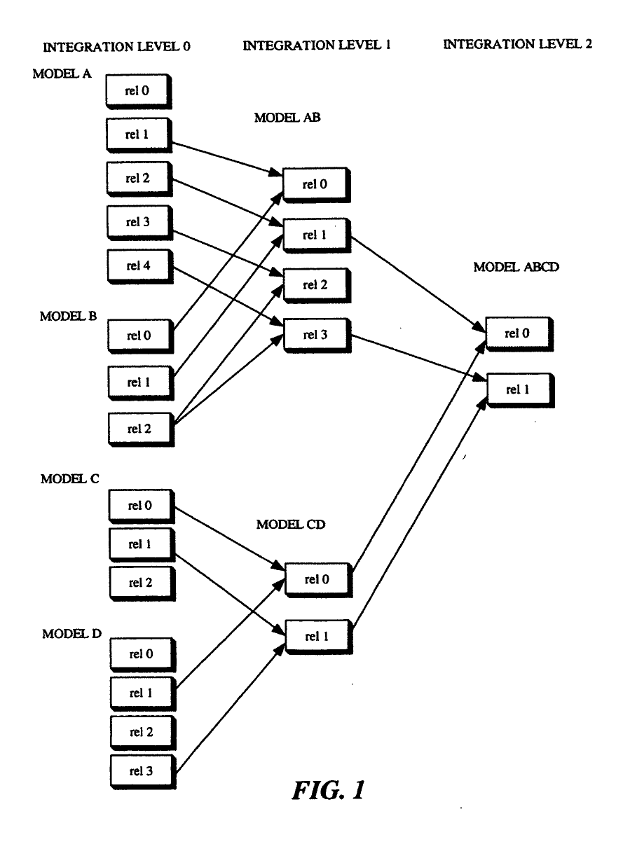

Referring generally to FIGS. 1-3, a method for web-based simulation triage in accordance with an embodiment of the present invention is discussed. FIG. 1 illustrates an example of a triage process system integration scheme that may be used by the present invention. Integration level 0 may include logic blocks/models A, B, C and D. Each logic block/model may further include a plurality of releases. For example, Model A of Integration Level 0 may include five releases (abbreviated as rel 0, rel 1, rel 2, rel 3 and rel 4). Typically, simulation is performed on each release of each logic block/model. During the triage process, simulation results are examined, and those releases that have sufficient functionality (i.e, the least number of errors/simulation fails) may then be integrated at system integration level 1, where they may form logic blocks/models AB and CD. A next step of the triage process is to perform simulation on each release of logic blocks/models AB and CD. The simulation results pertaining to releases of logic blocks/models AB and CD may then be examined to determine functionality. Those releases of Integration Level 1 with sufficient functionality may be integrated into Integration Level 2, where they may form logic block/model ABCD. Simulation may then be performed for each release of logic block/model ABCD and so forth.

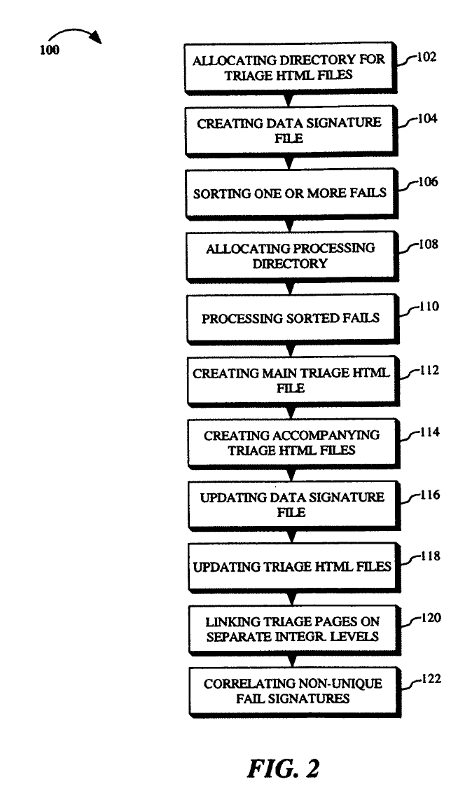

FIG. 2 is a flowchart illustrating a method for web-based simulation triage in accordance with an embodiment of the present invention. In a present embodiment, the method 100 may include a step of allocating a directory for one or more triage html files 102. The method 100 may further include a step of creating a single comprehensive data signature file/database 104. In a present embodiment, the data signature file/database may contain a list of all unique fail signatures corresponding to a plurality of releases of a plurality of logic blocks/models on a plurality of system integration levels. In an exemplary embodiment, the data signature file/database may quote each fail signature and assign a unique ID for each unique fail. Preferably, no additional information is provided. The purpose of the data signature file/database is to identify unique fail signatures which may be used later for debug purposes.

The method 100 may further include a step of sorting one or more fails for each release, the fails being found in a simulation database 106. In an exemplary embodiment, the fails may be sorted alphabetically by release and model name, alphabetically by fail signature and by increasing order of simulation fail time. Sorting fail signatures in the above-described manner may make it easier for users to select a particular fail signature corresponding to a particular release, which may be helpful during debugging applications. In additional embodiments, said sorting step 106 may be performed for each of the plurality of releases of each of the plurality of logic blocks/models on each of the plurality of hierarchical (system integration) levels at scheduled intervals.

The method 100 may further include a step of allocating a directory for processing sorted fails 108. The method 100 may further include a step of processing sorted fails for isolating corresponding unique fail signatures 110. In exemplary embodiments, the allocation 108 and processing 110 steps may be performed for each release of each logic block/model on each hierarchical (system integration) level at scheduled intervals.

The method 100 may further include a step of creating a main triage html file for each release of each logic block/model on each system integration level 112. In a current embodiment, step 112 may be performed only in an initial run.

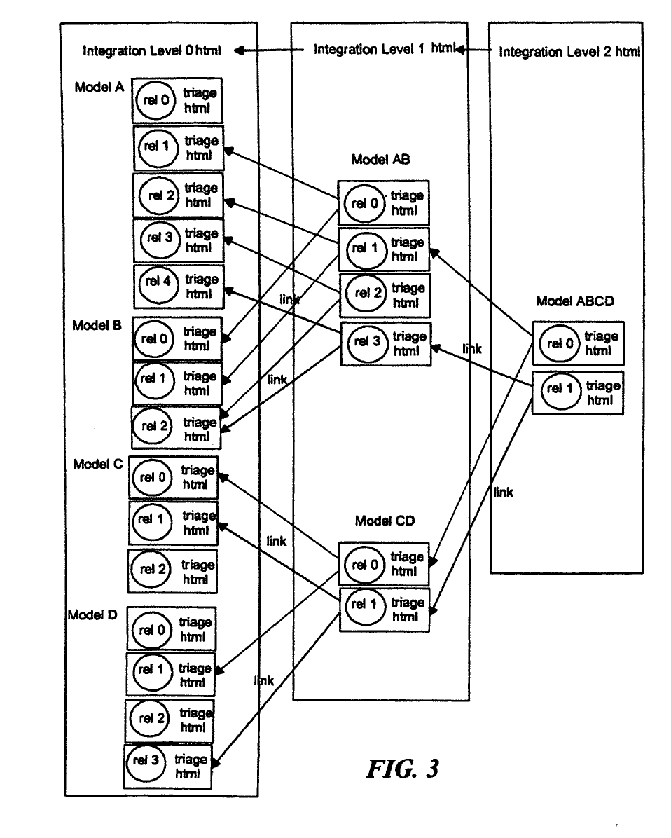

The method 100 may further include a step of creating a plurality of accompanying triage html files 114 for each release of each logic block/model on each system integration level. In an exemplary embodiment, one or more of a composition triage html file, a fail signature triage html file, a statistics triage html file and a problem tracking file may be created for each release of each logic block/model on each hierarchical (system integration) level. For instance, the composition triage html file may list html links to triage pages for all releases on a next lower integration level that an analyzed release is composed of. A schematic of the links is illustrated in FIG. 3. The fail signature triage html file may list data such as fail signatures, unique IDs, unique marks, status and owner. The fail signature triage html file may be automatically created, manually created or both. The statistics triage html file may list causes of fails as quantitative numbers or give other relevant statistical information. Further, the problem-tracking triage html file may list tracking problems and/or issue numbers assigned to each particular fail. It is further contemplated that one or more of the composition, fail signature, statistics and problem-tracking triage html files may be updated at regular intervals, either automatically, manually or both.

The method 100 may further include a step of updating the comprehensive data signature file/database with a fail signature if the fail signature is unique 116. The method 100 may further include a step of updating information in one or more of the triage html files for one or more releases as the information becomes available 118. For example, if a fail signature for a release is determined to be unique, the updating step 118 may involve marking the fail signature as unique in the fail signature triage html file for that release. Alternatively, if a fail signature for a release is not unique, the updating step 118 may involve marking the fail signature as not unique in the fail signature triage html file for that release. In an exemplary embodiment, step 118 may be done manually. In further embodiments, step 118 may be automated.

The method 100 further includes a step of linking one or more html triage files, such as composition html triage files, for one or more releases on an analyzed system integration level to one or more html triage pages of one or more releases on a lower system integration level 120. FIG. 3 illustrates an example of a linking schematic which may be implemented with the method 100 of the present invention. For instance, referring to FIG. 3, a user analyzing releases (rel 0, rel 1) for Model/logic block ABCD on Integration Level 2 may want to determine which releases from Integration Level 1 were used to compose the releases of Model/logic block ABCD. As shown in FIG. 3, the present invention may provide html links which, for example, may link triage html pages of the releases of Model/logic block ABCD (rel 0, rel 1) to triage html pages of the releases of system integration level 1 used to compose Model/logic block ABCD. For example, following the linking schematic in FIG. 3, a user may be able to determine that release 0 (rel 0) of Model/logic block ABCD is composed of release 1 (rel 1) of Model/logic block AB and release 0 of Model/logic block CD. Knowing which releases were interfaced from previous integration levels may help a user derive more benefit from information provided during analysis of simulations performed on a higher integration level. The method 100 may further include a step of correlating one or more fail signatures which are not unique to the lower system integration level 122.

It is to be noted that the foregoing described embodiments according to the present invention may be conveniently implemented using conventional general purpose digital computers programmed according to the teachings of the present specification, as will be apparent to those skilled in the computer art. Appropriate software coding may readily be prepared by skilled programmers based on the teachings of the present disclosure, as will be apparent to those skilled in the software art.

It is to be understood that the present invention may be conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method may be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A method for web-based triage, comprising:
allocating a directory for one or more triage html files;
creating a data signature file;
sorting one or more fails corresponding to one or more releases; and
allocating a processing directory.

2. A method as claimed in claim 1, wherein said method further comprises a step of processing the one or more sorted fails for isolating one or more unique fail signatures.

3. A method as claimed in claim 1, wherein said method further comprises a step of creating a plurality of triage html files for each of the one or more releases.

4. A method as claimed in claim 1, wherein said method further comprises a step of updating the data signature file with one or more unique fail signatures.

5. A method as claimed in claim 3, wherein said method further comprises a step of updating information in one or more of the triage html files for one or more releases as the information becomes available.

6. A method as claimed in claim 3, wherein said method further comprises a step of linking one or more html triage files for one or more releases on an analyzed system integration level to one or more triage pages for one or more releases on a lower system integration level.

7. A method as claimed in claim 6, wherein said method further comprises a step of correlating one or more non-unique fail signatures to the lower system integration level.

8. A computer-readable medium having computer executable instructions for performing a method of web-based triage, the method comprising steps of:
allocating a directory for one or more triage html files;
creating a data signature file;
sorting one or more fails corresponding to one or more releases; and
allocating a processing directory.

9. The computer-readable medium of claim 8, wherein said method further comprises a step of processing the one or more sorted fails for isolating one or more unique fail signatures.

10. The computer-readable medium of claim 8, wherein said method further comprises a step of creating a plurality of triage html files for each of the one or more releases.

11. The computer-readable medium of claim 8, wherein said method further comprises a step of updating the data signature file with one or more unique fail signatures.

12. The computer-readable medium of claim 10, wherein said method further comprises a step of updating information in one or more of the triage html files for one or more releases as the information becomes available.

13. The computer-readable medium of claim 10, wherein said method further comprises a step of linking one or more html triage files for one or more releases on an analyzed system integration level to one or more triage pages for one or more releases on a lower system integration level.

14. The computer-readable medium of claim 13, wherein said method further comprises a step of correlating one or more non-unique fail signatures to the lower system integration level.

15. A method for web-based triage, comprising:
allocating a directory for one or more triage html files;
creating a data signature file;
sorting one or more fails corresponding to one or more releases;
allocating a processing directory; and
processing the one or more sorted fails for isolating one or more unique fail signatures.

16. A method as claimed in claim 15, wherein said method further comprises a step of creating a plurality of triage html files for each of the one or more releases.

17. A method as claimed in claim 15, wherein said method further comprises a step of updating the data signature file with one or more unique fail signatures.

18. A method as claimed in claim 16, wherein said method further comprises a step of updating information in one or more of the triage html files for one or more releases as the information becomes available.

19. A method as claimed in claim 16, wherein said method further comprises a step of linking one or more html triage files for one or more releases on an analyzed system integration level to one or more triage pages for one or more releases on a lower system integration level.

20. A method as claimed in claim 19, wherein said method further comprises a step of correlating one or more non-unique fail signatures to the lower system integration level.
